(19) United States
(12) Patent Application Publication
(10) Pub. No.: US 2023/0064846 A1
(43) Pub. Date: Mar. 2, 2023

(54) FAILURE KNOWLEDGE STRUCTURE SYSTEM AND FAILURE KNOWLEDGE STRUCTURE METHOD

(71) Applicant: Hitachi, Ltd., Tokyo (JP)

(72) Inventors: Tomoaki MORIOKA, Tokyo (JP); Yasuharu NAMBA, Tokyo (JP); Shuntaro HITOMI, Tokyo (JP)

(73) Assignee: Hitachi, Ltd., Tokyo (JP)

(21) Appl. No.: 17/686,763

(22) Filed: Mar. 4, 2022

(30) Foreign Application Priority Data
Aug. 26, 2021 (JP) 2021-138061

(51) Int. Cl. G06F 16/25; G06F 16/22; G06F 16/215

(52) U.S. Cl. CPC G06F 16/252; G06F 16/215; G06F 16/2228

(57) ABSTRACT

A failure knowledge structure system including: a failure knowledge database, execution procedures of actions and maintenance as maintenance information regarding a maintenance target instrument; an expression extraction unit that extracts failure expressions and action expressions from a maintenance document; a name identification unit that calculates the occurrence frequencies of execution procedures of maintenance executed before the failure expressions and the action expressions and after the failure expressions and the action expressions on the basis of extraction results of the expression unit and information regarding the execution procedures of maintenance stored in the failure knowledge database, and that further calculates distances between distributions of the failure expressions and distances between distributions of the action expressions; an input/output unit that draws the processing results of the name identification unit as name identification candidates, and that makes it possible to execute a manual editing operation; and a database editing unit.

### CLAIM OF PRIORITY

The present application claims priority from Japanese Patent Application Serial No. 2021-138061, filed on Aug. 26, 2021, the content of which is hereby incorporated by reference into this application.

### BACKGROUND OF THE INVENTION

The present invention relates to failure knowledge construction systems and failure knowledge structure methods.

In order to solve the shortage of personnel in all fields, methods for performing effective maintenance by collecting and utilizing knowledges about maintenance have been required. However, introduction costs for such methods becomes considerably large since it requires a lot of man-hours to manually construct knowledges that are indispensable for effective maintenance and that are arranged in the form of a database. Therefore, technologies for automatically extract knowledges relating to maintenance from maintenance-related documents are required.

As a technology relating to extracting information from documents, a technology disclosed in Japanese Unexamined Patent Application Publication No. 2013-29891 is known for example. Japanese Unexamined Patent Application Publication No. 2013-29891 discloses a technology in which, in order to suppress the increase of an extraction processing load due to the increase of extraction target data composed of similar character strings, “an extraction program, which extracts a character string the editing distance of which to a predetermined character string is less than or equal to a predetermined number (d) from a character string group, causes a computer to execute processing for extracting one or more partial character strings each of which is composed of continuing characters within the predetermined character string and the number (n) of the continuing characters is smaller than a quotient obtained by dividing a number (m) of characters in the predetermined character string by the predetermined number (d), to extract a character string containing any one of the extracted one or more partial character strings from the character string group, and to determine whether or not an editing distance between the character string extracted from the character string group and the predetermined character string is less than or equal to the predetermined distance (d)”.

### SUMMARY OF THE INVENTION

In the case of extracting pieces of knowledge information from a document, it is regarded as a difficult problem to execute name identification that brings together pieces of information having similar meanings into one piece of information, and various methods have been proposed. Japanese Unexamined Patent Application Publication No. 2013-29891 discloses a method in which, in the extraction of information from a document, name identification is executed in such a way that the magnitude of an editing distance between two extracted character strings is judged, and if the distance is short, the two extracted character strings are name-identified.

However, this method cannot name-identify character strings that are quite different from one another in terms of character strings. In addition, in the field of maintenance, there are ways of using words different from ways of using general words, or there are technical terms, so that there are some cases where name identification methods used for general natural language processing cannot be applied to the field of maintenance.

For the reasons stated above, a system and a method that execute name identification with the use of relationships among pieces of information that is characteristic of maintenance become indispensable when the name identification is executed.

With the above in mind, the present invention is achieved to provide “a failure knowledge structure system including: a failure knowledge database that accumulates and stores failures, execution procedures of actions and maintenance as maintenance information regarding a maintenance target instrument; an expression extraction unit that extracts failure expressions and action expressions from a maintenance document that describes the maintenance information regarding the maintenance target instrument; a name identification unit that calculates the occurrence frequencies of execution procedures of maintenance executed before the failure expressions and the action expressions and after the failure expressions and the action expressions on the basis of extraction results of the expression unit and information regarding the execution procedures of maintenance stored in the failure knowledge database, and that further calculates distances between distributions of the failure expressions and distances between distributions of the action expressions; an input/output unit that draws processing results of the name identification unit as name identification candidates, and that makes it possible to execute manual editing operations; and a database editing unit that edits information from the input/output unit and stores the results in the failure knowledge database”.

Furthermore, the present invention is achieved to provide “a failure knowledge structure method including the steps of: extracting a plurality of failure expressions that describe failure contents of a maintenance target instrument and the parts thereof and a plurality of action expressions that describe action contents executed against the failure contents from a maintenance document that describes maintenance information regarding the maintenance target instrument; obtaining a combination of each of the plurality of failures and each of the plurality of actions; and executing name identification processing a certain number of times according to the number of descriptions of action expressions for a specific failure expression; and reflecting information, in which the result of human judgment regarding the results of the name identification processing is reflected, in the failure knowledge database as failure knowledges”.

Using a failure knowledge structure system and a failure knowledge structure method according to the present invention, the accuracy of name identification that extracts knowledges regarding maintenance from a document is improved. With this, it becomes possible to generate data regarding maintenance-related knowledges of higher quality. In addition, the man-hours required to structure such maintenance-related knowledge data are reduced.

### BRIEF DESCRIPTION OF THE DRAWINGS

FIG. 1 is a diagram used for explaining the fundamental concept of a failure knowledge structure system 1;

FIG. 2 is a diagram for schematically showing the maintenance contents as a configuration example of a failure knowledge database DB;

FIG. 3 is a diagram showing examples of properties possessed by a part node;

FIG. 4 is a diagram showing examples of properties possessed by a failure node;

FIG. 5 is a diagram showing examples of properties possessed by an action node;

FIG. 6 is a diagram showing an example of a pre/post-failure procedure map and an example of a pre/post-action procedure map;

FIG. 7 is a diagram showing an entire configuration example of a failure knowledge structure system according to a second embodiment of the present invention;

FIG. 8 is a diagram showing examples of the extraction results of an expression extraction unit 21;

FIG. 9 is a diagram showing the processing contents of a name identification unit 22 according to the second embodiment of the present invention in detail;

FIG. 10 is a flowchart showing the steps executed in the name identification unit 22;

FIG. 11 is a diagram showing the edited results of extraction result data;

FIG. 12 is a diagram showing an example of the pre/post-failure procedure map after the addition of extraction results and the pre/post-action procedure map after the addition of extraction results;

FIG. 13 is a diagram showing an example of a drawing regarding a failure expression;

FIG. 14 is a diagram showing an example of a manual editing screen of a failure expression;

FIG. 15 is a diagram showing an example of data obtained by editing data extracted by the expression extraction unit 21;

FIG. 16 is a diagram minutely showing the processing contents of a name identification unit 22 according to a third embodiment of the present invention in detail;

FIG. 17 is a diagram showing the output of a procedure deficit probability calculation unit 1501; and

FIG. 18 is a diagram showing the output of an extracted data deficit complementary unit 1502.

### DETAILED DESCRIPTION OF THE PREFERRED EMBODIMENTS

Hereinafter, embodiments of the present invention will be explained with reference to the accompanying drawings.

### First Embodiment

In a first embodiment, the fundamental processing concept of the present invention will be explained. An object of the present invention is to simply structure a high-accuracy failure knowledge database through name identification processing using pieces of information described in a maintenance execution log which are records and reports made by maintenance persons when steps of maintenance are executed for instruments and the parts thereof.

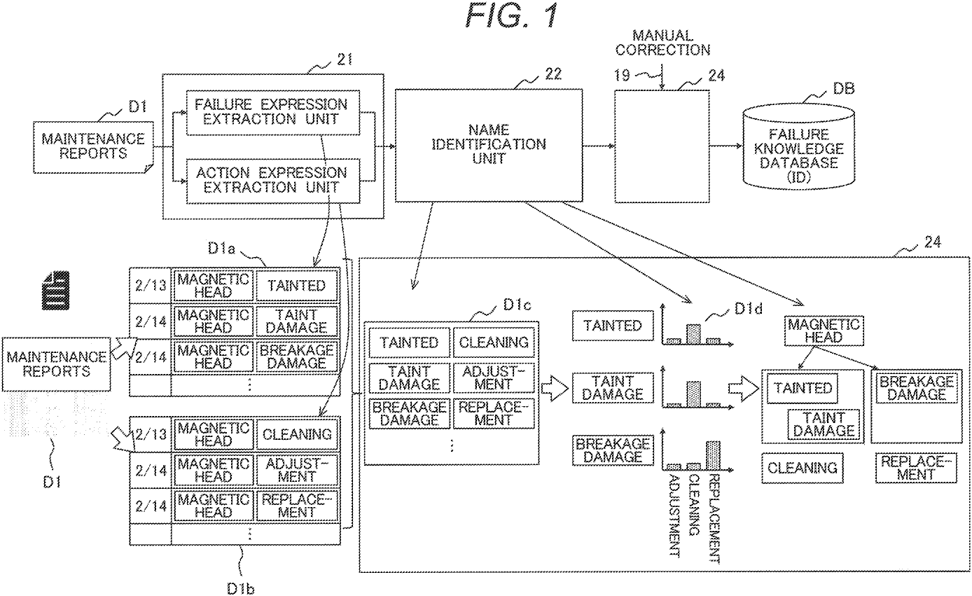

FIG. 1 is a diagram used for explaining the fundamental concept of a failure knowledge structure system 1. The failure knowledge structure system 1 is configured with a computer, and includes: a temporary storage unit M and a failure knowledge database DB in a storage unit 10; and the functions of an expression extraction unit 21, a name identification unit 22, and a database editing unit 23 as functions executed in a calculation unit 20. Furthermore, the failure knowledge structure system 1 is in cooperation with a database editor 19 via an input/output unit 24.

In the fundamental concept diagram shown in FIG. 1, various contents are described in free description formats in a maintenance execution log D1, and the maintenance execution log D1 includes failure content information D1a regarding failure contents and action information D1b regarding actions taken against the failure contents. In the failure content information D1a, the failure contents of a magnetic head are freely described with expressions such as “tainted”, “taint damage”, and “breakage damage” as well as dates and part names. In addition, in the action information D1b, action contents are freely described with expressions such as “cleaning”, “adjustment”, “replacement” and the like as well as dates and part names. In this case, although all of the expressions “tainted”, “taint damage”, and “breakage damage” express failure contents, how to express each of the failure contents differs greatly from maintenance person to maintenance person. Furthermore, there is a possibility that any of the failure contents is expressed by another synonymous term instead of an already-used term.

The expression extraction unit 21 extracts “tainted”, “taint damage”, and “breakage damage”, which are expressions of the failure contents included in the failure content information D1a, from many terms described in free description formats in the maintenance execution log D1, and further extracts “cleaning” and “replacement” which are expressions of the action contents included in the action information D1b.

In the name identification unit 22, combinations D1c of the failure content expressions “tainted”, “taint damage”, and “breakage damage” and the action content expressions “cleaning”, “adjustment”, and “replacement” are generated. Next, in the name identification unit 22, the occurrence frequencies of the action expressions against each of the failure content expressions are calculated and term occurrence frequency information D1d is obtained. To cite one example shown in FIG. 1, the occurrence frequencies of the action terms “cleaning”, “adjustment”, and “replacement” corresponding to the case where a failure term is “tainted” are calculated. In a similar way, the occurrence frequencies of the action terms corresponding to the cases where failure terms are “taint damage” and “breakage damage” are calculated. In addition, in the name identification unit 22, post-name identification information D1e is obtained from combinations D1c with high occurrence frequencies. In the above examples, it is judged that the failure expressions "tainted" and "taint damage" are regarded as synonymous with each other, and there is the highest probability that the action "cleaning" is executed against both failure expressions "tainted" and "taint damage." Furthermore, on the other hand, "breakage damage" is a failure event different from "tainted" and "taint damage", and it is judged that there is the highest probability that the action "replacement" is executed in the case of "breakage damage".

Pieces of information D1c, D1d, D1e, and the like, which are calculated by the name identification unit 22 as intermediary products, are set able to be outputted to the outside via the input/output unit 24, and after being edited by the database editor 19, these pieces of information are stored in the failure knowledge database DB as failure knowledges D.

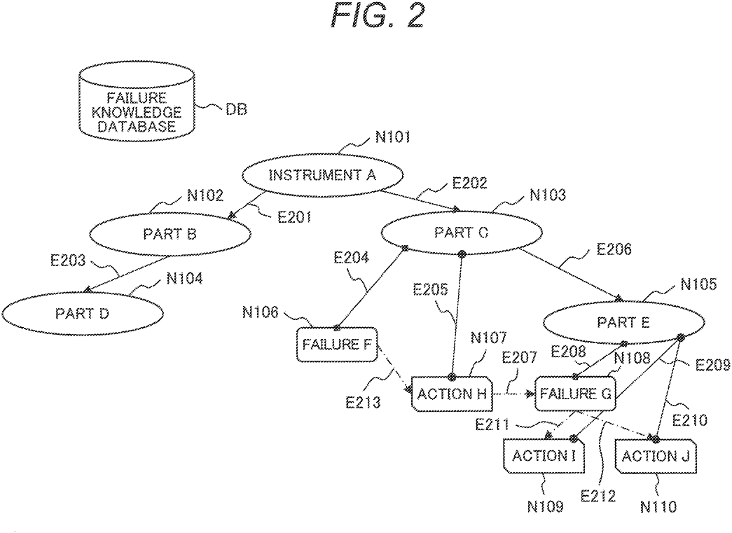

A configuration example of the failure knowledge database DB configured as mentioned above by name identification is shown in FIG. 2 to FIG. 5. First, FIG. 2 shows a configuration example of the failure knowledge database DB. FIG. 2 is a diagram schematically showing maintenance contents, and it is a diagram showing an example of a relationship of the configuration of a target instrument and the parts thereof, failures, and actions against the failures. In the failure knowledge database DB, failures and the procedures of actions and maintenance are accumulated and stored as maintenance information regarding maintenance target instruments.

According to the relationship described in FIG. 2, a maintenance target instrument A is composed of a part B and a part C, and the part B and the part C include a part D and a part E respectively. In addition, FIG. 2 shows a failure F occurring at the part C and an action H against the failure F, a failure G occurring at the part E and an action I and an action J against the failure G, and a relationship between the action H, which is involved with both part C and part E, and the failure G.

The storage scheme of the failure knowledge database DB, which stores these pieces of information regarding the instrument A, is achieved by a graph database that is composed of nodes N and edges E showing the relationships among the nodes N. It is conceivable that the nodes N and the edges E possess pieces of additional information called properties respectively as well as items shown in FIG. 2.

In FIG. 2, the nodes N are general terms for the instrument A and the parts B to E thereof shown by ovals; and the failures F and G and actions H, I, and J shown by rectangles, and these nodes N respectively represents part nodes (N101 to N105), failure nodes (N106 and N108), and action nodes (N107, N109, and N110).

Furthermore, the edges E show relationships between the nodes N, and the edges E shows that, in the failure knowledge database DB, edges E201, E202, E203, and E206 show parent-child relationships between parts or between the instrument and parts, edges E204 and E208 show part-failure relationships between parts and failures, edges E205, E209, and E210 show part-action relationships between parts and actions, and edges E207, E211, E212, and E213 show execution procedure relationships between failures and actions.

Here, it is also conceivable that the failure knowledge database DB includes pieces of information that are pieces of property information associated with the abovementioned edges and that should be stored as additional pieces of information. For example, it is conceivable that pieces of information regarding inspection items, which are used when failure causes are investigated, are added as nodes, or cause-and-effect relationships between failures are added as edges. In addition, it is also thinkable that the types of nodes shown in FIG. 2 are further subdivided. For example, each of the action nodes (N107, N109, and N110) may be subdivided into work nodes to be executed and action nodes for repairing failures, or each of the failure nodes (N106, N108) may be subdivided into nodes corresponding to symptoms, external causes, internal causes, and the like.

As mentioned above, the failure knowledge database DB stores failure knowledges D regarding the maintenance target instrument as data. The failure knowledges D stored in the failure knowledge database DB can be utilized for various types of maintenance services and cooperation between design work and operation work. For example, the failure knowledges D can be utilized for a system that gives instructions for procedures of repairs to maintenance persons and a system that estimates the causes of failures. Information inside of the failure knowledge database DB is utilized in the processing executed in the name identification unit 22. Furthermore, results that are finally edited by a database editor 19 are stored in the failure knowledge database DB. The implementation configuration of the failure knowledge database DB is not limited to the implementation configuration of a relational database but may be the implementation configuration of a graph database. In this embodiment, the implementation configuration of a graph database is explained in FIG. 2.

In the failure knowledge database DB, parts are defined by the following nodes N and edges E being used in cooperation with one another. The part nodes (N101 to N105) of the nodes N include pieces of information regarding the relevant parts respectively. The parent-child relationships of the parts are described by the part parent-child relationship edges (E201, E202, E203, and E206). In addition, information regarding what types of failures the parts cause respectively is described in the part-failure relationship edges (E204 and E208). What types of actions should be executed against the parts respectively in the procedures of maintenance works are described in the part-action relationship edges (E205, E209, and E210).

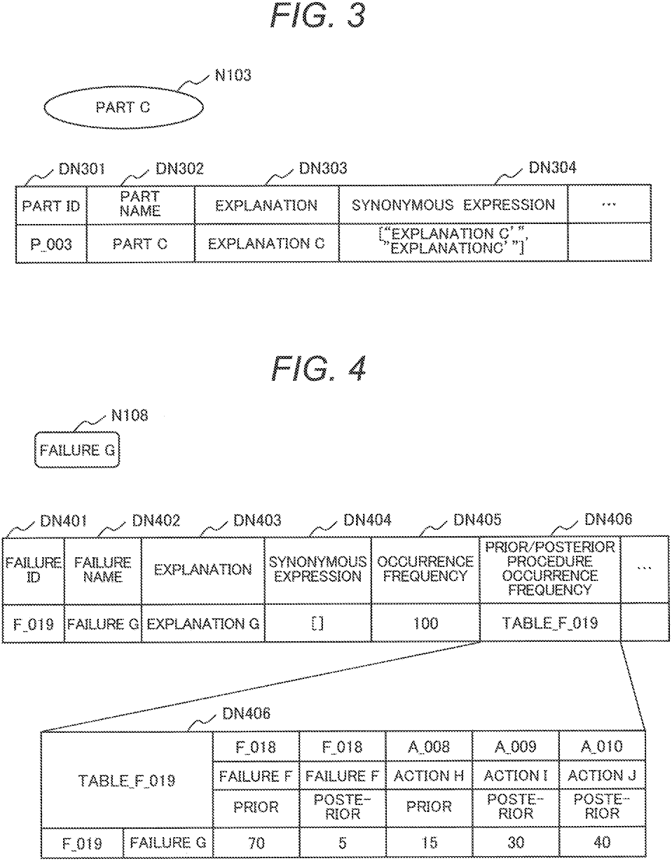

An example of the properties of the part nodes (N101 to N105), which are corresponding to main information regarding the parts, will be shown in FIG. 3. FIG. 3 shows examples of the properties (DN301 to DN304) of the part node N103, and some properties other than the properties shown in FIG. 3 may be included in the part node N103. Part ID (DN301) is a column for housing a part ID that uniquely specifies a part in the failure knowledge database DB, and in this example, P_003 is defined as the part ID. Here, the part ID P_003 in Part ID (DN301) of the part node N103 does not become identical with a part ID in Part ID (DN301) of any of other part nodes. Part Name DN302 is a column for housing a part name, and in this case, the part C is defined. Here, the part C may be identical with a part name in Part Name DN302 of any of other nodes, but in this case, the part name extracted by the expression extraction unit 21 needs to be associated with the relevant part node of the part nodes (N101 to N105) by the name identification unit 22.

It will be assumed that, as other properties, there are an explanation described in Explanation DN303 and a synonymous expression described in Synonymous Expression DN304 in FIG. 3. Explanation C is described in Explanation DN303 as an explanation about the part C, and in addition to this, Explanation C′ or Explanation C″ is described in Synonymous Expression DN304 as an explanation about the part C. The above means that, although Explanation C, Explanation C′, and Explanation C″ differ in their expressions, they fundamentally explain the same thing. Here, a synonymous expression described in Synonymous Expression DN304 is useful when a part name extracted by the expression extraction unit 21 is associated with the relevant part node of the part nodes (N101 to N 105).

The part parent-child relationship edges (E201, E202, E203, E206) are directed edges showing parent-child relationships between the parts as shown by arrows in FIG. 2. In the example shown in FIG. 2, a knowledge regarding the part structure expansion of the instrument A in which the part B and part C exist as the components of the instrument A and the part B includes the part D is described.

The part-failure relationship edges (E204 and E208) are directed edges showing what types of failures occur in what parts respectively as shown by arrows in FIG. 2. For example, FIG. 2 shows that the failure F occurs in the part C.

The part-action relationship edges (E205, E209, and E210) are directed edges showing what types of actions are executed against what parts respectively as shown by arrows in FIG. 2. For example, FIG. 2 describes a work referred to as the action H executed against the part C.

According to the failure knowledge database DB, failures are defined by the following nodes N and edges E being used in cooperation with one another. The failure nodes (N106 and N108) of the nodes N include pieces of failure information respectively. Parts associated with the failure nodes (N106 and N108) are shown by the part-failure relationship edges (E204 and E208) respectively. Maintenance execution procedures before/after the failure nodes N106 or N108 are described by the execution procedure relationship edges (E207, E211, E212, and E213), and the part C and the part E are associated with the failure nodes (N106 and N108) and the action nodes (N107, N109, and N110) by this description. Properties possessed by the failure nodes (N106 and N108) will be explained with reference to FIG. 4.

FIG. 4 shows examples of the properties of the failure node N108. Properties described in the columns DN401 to DN406 are examples, and it is conceivable that the failure node N108 includes a property other than the properties shown in FIG. 4. F_019 described in Failure ID (DN401) is an ID for uniquely specifying a failure node. Here, F_019 in Failure ID (DN401) of the part node N108 does not become identical with a failure ID described in Failure ID (DN401) of any of other failure nodes. Failure Name DN402 houses a typical name of the failure.

Explanation DN403 describes explanation information regarding the failure. Furthermore, Synonymous Expression DN404 describes an expression that is used for expressing the failure event shown by the failure node 202 (N108) and that is other than the expression specified by Failure Name DN402. Explanation DN403 describes explanation about the failure G as Explanation G, and furthermore, if an expression synonymous with the failure G exists, the synonymous expression is described in Synonymous Expression DN404. The above shows that, although there is a difference between these expressions, they are fundamentally the same explanations about the same thing. In the example shown in FIG. 1, the failure expressions “tainted” and “taint damage” correspond to different expressions about the same thing. The expression of the relevant failure and the expressions of failures that should be brought together that are obtained as the results of the name identification processing of the present invention are stored in this Synonymous Expression DN404. Afterward, when knowledge extraction is newly executed, these expressions are used at the time results extracted by the expression extraction unit 21 are associated with the failure nodes (N106 and N108) as a piece of processing executed by the name identification unit 22.

Occurrence Frequency DN405 stores the number of occurrences of the failure event expressed by the failure node N108 at the time knowledge extraction is executed from the past maintenance execution log D1. In addition, Prior/Posterior Procedure Occurrence Frequency DN406 stores the occurrence frequencies of other failure nodes (N106 and N108) and action nodes (N107, N109, and N110), that is, how many times the other failure nodes and the action nodes appeared as procedures, before or after the time an expression corresponding to the failure node N108 (the failure G) is extracted from the maintenance execution log D1.

Data stored in Prior/Posterior Procedure Occurrence Frequency DN406 is stored in the form of table data. In FIG. 4, the types of procedures, which are executed before and after the failure F_019 (the failure G) at the relevant failure node N108 along the vertical axis, are described along the horizontal axis. For example, data stored in Prior/Posterior Procedure Occurrence Frequency DN406 is stored in such a way that A_008 (N107), which is one of action nodes (N107, N109, and N110), is described 15 times as a procedure before F_019 in the past maintenance execution log D1, and A_009 (N110) is described 30 times as a procedure after F_019 in the past maintenance execution log D1.

In such a way, information regarding a node ID, which is corresponding to a procedure executed before or after a failure, whether the expression of the procedure is described as a procedure to be executed before the failure or after the failure, and the occurrence frequency of the procedure is shown. Other nodes that are targets which are described in Prior/Posterior Procedure Occurrence Frequency DN406 are nodes that are connected to the relevant failure node (N106 and N108) with the execution procedure relationship edges (E207, E211, E212, and E213) or nodes that exist ahead of the execution procedure relationship edges (E207, E211, E212, and E213). For example, in the case of the failure G of the part E shown in FIG. 2, not only the action node called the action H of the part C connected via the execution procedure relationship edge E207, but also the failure node N106 called the failure F of the part C existing ahead of the action H is a target node of Prior/Posterior Procedure Occurrence Frequency DN406. Data described in Occurrence Frequency DN405 and Prior/Posterior Procedure Occurrence Frequency DN406 is used at the time distribution calculation is executed in the name identification unit 22.

The execution procedure relationship edges (E207, E211, E212, and E213) are directed edges having information regarding the maintenance execution procedures. In the example shown in FIG. 2, a work procedure such that, when the part C becomes in the state of the failure F, the action H is executed for the part C, and a work procedure such that, when the part E becomes in the state of the failure G, the action I is executed for the part E or the action J is executed for the part E are described. An execution procedure may have a branch, so it is conceivable that one node extends the execution procedure relationship edges (E207, E211, E212, and E213) to plural nodes, or the execution relationship edges (E207, E211, E212, and E213) reach one node from plural nodes.

Furthermore, according to the failure knowledge database DB, actions are defined by the following nodes N and edges E being used in cooperation with one another. Of the nodes N, the action nodes (N107, N109, and N110) have information regarding actions respectively. The parts associated with the action nodes (N107, N109, and N110) are described by the part-action relationship edges (E205, E209, and E210). The maintenance execution procedures before/after the failure nodes N106 or N108 are described by the execution procedure relationship edges (E207, E211, E212, and E213), and, and the part C and the part E are associated with the failure nodes (N106 and N108) and the action nodes (N107, N109, and N110) by this description.

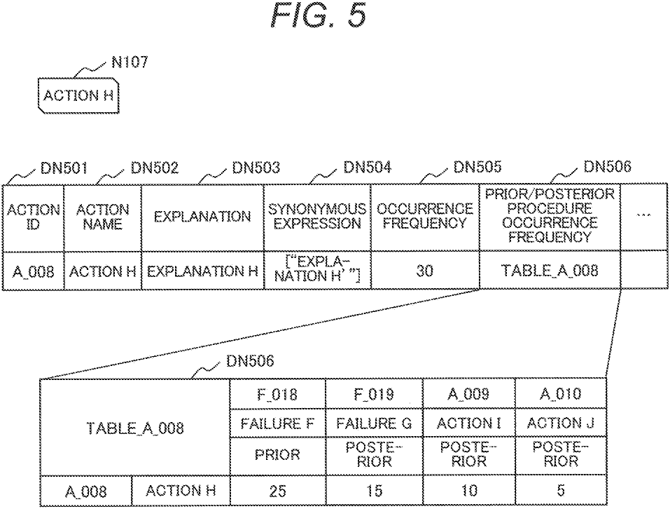

The properties of the action nodes (N107, N109, and N110) that are corresponding to main information regarding actions is shown in FIG. 5. FIG. 5 shows examples of properties regarding the action node N107 that are described in DN501 to DN506, and there may be properties other than the properties shown in FIG. 5. Data described in Action ID (DN501) is an action ID that uniquely represents one of the action nodes N107, N109, and N110. The above action ID does not become identical with an action ID described in Action ID (DN501) of each of other action nodes. Action Name DN502 houses a typical name of the action.

The explanation of the action is described in Explanation DN503. In addition, Synonymous Expression DN504 stores an expression that is used when the action expressed by each of the action nodes (N107, N109, and N110) is mentioned and that is other than an expression described in Action Name DN502. A synonymous expression of the relevant action obtained as a result of executing the present invention is stored in Synonymous Expression DN504. In the case of FIG. 5, an explanation regarding the action H is described as Explanation H in Explanation DN503, and further an explanation regarding the action H is described as Explanation H′ in Synonymous Expression DN504 of the action H. The above shows that, although there is a difference between these expressions, they are fundamentally the same explanations about the same thing. Afterward, when knowledge extraction is newly executed, these expressions are used at the time results extracted by the expression extraction unit 21 are associated with the action nodes (N107, N109, and N110) as a piece of processing executed by the name identification unit 22.

Occurrence Frequency DN505 stores the number of occurrences of the actions expressed by the action nodes (N107, N109, and N110) at the time knowledge extraction is executed from the past maintenance execution log D1. In addition, Prior/Posterior Procedure Occurrence Frequency DN506 stores the occurrence frequencies of other failure nodes (N106 and N108) and action nodes (N107, N109, and N110), that is, how many times the other failure nodes and action nodes appeared as procedures, before or after the time expressions corresponding to the action nodes (N107, N109, and N110) were extracted from the maintenance execution log D1. Data stored in Prior/Posterior Procedure Occurrence Frequency DN406 is stored in the form of table data.

In FIG. 5, the types of procedures, which are executed before and after the action A_008 (the action H) at the relevant action node N107 along the vertical axis, are described along the horizontal axis. For example, data stored in Prior/Posterior Procedure Occurrence Frequency DN506 is stored in such a way that A_009 (the action I) of the action node N109, which is one of action nodes (N107, N109, and N110), is described 10 times as a procedure after A_008 in the past maintenance execution log D1. In such a way, information regarding a node ID, which corresponds to a procedure executed before or after an action, whether the expression of the node ID is described as a procedure to be executed before the action or after the action, and the occurrence frequency of an action corresponding to the node ID is shown. Other nodes that are targets which are described in Prior/Posterior Procedure Occurrence Frequency DN506 are nodes that are connected to the relevant action node (N107, N109, and N110) with the execution procedure relationship edges (E206, E207, E211, and E212), or nodes that exist ahead of the execution procedure relationship edges (E206, E207, E211, and E212). Data described in Occurrence Frequency DN505 and Prior/Posterior Procedure Occurrence Frequency DN506 is used at the time distribution calculation is executed in the after-mentioned name identification unit 22.

In the above explanations of the first embodiment of the present invention, the fundamental processing concept of the present invention and the data stored in the failure knowledge database DB obtained as the results of the installation of the first embodiment have been described. Explanations regarding parts, failures, and actions summed up using FIG. 3. FIG. 4, and FIG. 5 as well as synonymous expressions obtained by name identification processing are to be understood.

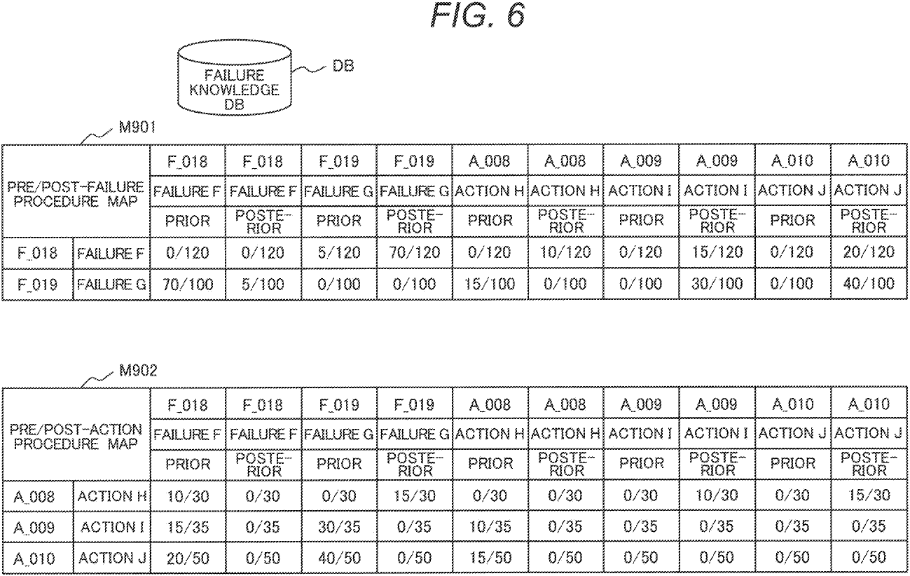

Furthermore, in the present invention, an example of a pre/post-failure procedure map and an example of a pre/post-action procedure map shown in FIG. 6 are stored. A pre/post-failure procedure map M901 shown in FIG. 6 is a map in which the failure F and the failure G are set along the vertical axis as standard failures, and the empirical occurrence number of each of the failure F, the failure G, the action H, the action I, and the action J, which occurred before and after these failure events, is brought together along the horizontal axis. In a similar way, a pre/post-action procedure map M902 shown in FIG. 6 is a map in which the action H, the action I, and the action J are set along the vertical axis as standard actions, and the empirical occurrence number of each of the failure F, the failure G, the action H, the action I, and the action J, which occurred before and after these action events, is brought together along the horizontal axis.

For example, in the pre/post-failure procedure map M901, while the past total empirical occurrence number of events that occurred before or after the failure F is 120, the occurrence number of each of the events is gotten together and described in the relevant cell, so that, with the use of this map, the order of the occurrences of the failure events and action events shown in FIG. 2 is clarified. Prior/posterior procedure maps can be generated using the execution procedure relationship edges (E207, E211, E212, and E213). Here, the prior/posterior procedure maps are generic names for the pre/post-failure procedure map and the pre/post-action procedure map.

### Second Embodiment

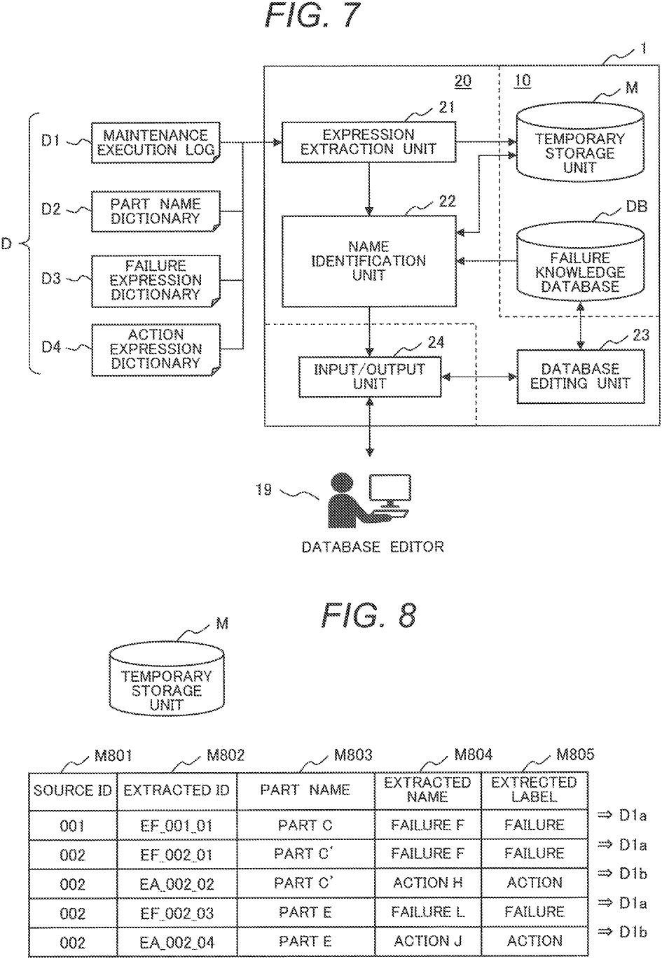

In a second embodiment, a concrete technique for materializing the fundamental concept of the first embodiment will be explained. First, FIG. 7 is a diagram showing an entire configuration example of a failure knowledge structure system according to the second embodiment of the present invention.

A failure knowledge structure system 1 includes a memory unit 10 equipped with a temporary storage unit M and a failure knowledge database DB; executes the respective functions of an expression extraction unit 21, a name identification unit 22, and a database editing unit 23 as pieces of processing of the calculation unit 20; displays data for a database editor 19 via an input/output unit 24; brings in inputs from the database editor 19; executes pieces of processing in accordance with the contents of the inputs; and reflects and stores the result of human reexamination in the failure knowledge database DB.

It is conceivable that the failure knowledge structure system 1 prepares and stores in advance the relationship shown in FIG. 2 regarding an existing maintenance instrument A in the failure knowledge database DB. On top of that, the failure knowledge structure system 1 executes name identification processing in order to enrich information in the failure knowledge database DB and improve the contents thereof using various new types of information D regarding maintenance.

It will be assumed that a maintenance execution log D1 of these various new types of information D regarding maintenance includes log data obtained by accumulating maintenance achievements regarding the instrument A that is a maintenance target, and the maintenance execution log D1 is recorded in the form of text data, table data, or the like that are described in a natural language. The maintenance execution log D1 includes information D1a regarding the contents of failures of instruments and the parts thereof and information D1b regarding actions executed against those failures as maintenance information regarding maintenance executed on the instruments and the parts thereof.

In addition, as various new types of information D regarding maintenance, a part name dictionary D2, a failure expression dictionary D3, and an action expression dictionary D4 should be stored. These are dictionaries that respectively listing: the part names of the part B, the part C, the part D, and the part E; the expressions of the failure F and the failure G; and the expressions of the action H, the action I, and the action J regarding the maintenance target instrument A in the relationships among the configuration of the instrument, the failures, and the actions shown in FIG. 2. The dictionaries are respectively used when the expressions of the failures and the expressions of the actions are extracted from the description contents of the maintenance execution log D1 that is described in the natural language in the expression extraction unit 21 in the failure knowledge structure system 1. Here, in the case where the expression extraction unit 21 is implemented using a machine learning method, if information equivalent to information included in the above dictionaries is included inside the relevant machine learning models, it is not necessary to prepare the above dictionaries outside.

To explain these dictionaries in more detail, the part name dictionary D2 stores, for example, the part name of “Part C” and the like shown in FIG. 2. It will be assumed that part names are identical with part names stored in the failure knowledge database DB respectively, or that information about expression fluctuations and the like are described in the failure knowledge database DB.

The failure expression dictionary D3 stores expressions used for explaining failure events such as “Failure G” shown in FIG. 2 for example. The action expression dictionary D4 stores expressions used for explaining actions in the maintenance/repair work such as “Action H” shown in FIG. 2 for example.

It will be assumed that the contents of an action are roughly classified into two, that is, a work and an action. The work is an expression for an action necessary in a procedure in the maintenance/repair work. The action is an expression for an action for repairing a failure event in the maintenance/repair work. Failure expressions described in the failure expression dictionary D3 and action expressions described in the action dictionary D4 are name-identified by the present invention and these name-identified failure expressions and action expressions become sources for information stored in the failure knowledge database DB. Therefore, it is not always necessary that the expressions stored in the failure expression dictionary D3 and the action dictionary D4 are equal to expressions that have already been stored in the failure knowledge database DB.

The expression extraction unit 21 brings in the maintenance execution log D1, and extracts information to be stored in the failure knowledge database DB from the maintenance execution log D1. Contents to be extracted are the names of parts, the name of the instrument, and descriptions (D1a and D1b) that express a failure and an action respectively. The extraction method may be installed on the basis of a certain rule using the part name dictionary D2, the failure expression dictionary D3, and the action expression dictionary D4, or may be installed as a machine learning model that utilizes statistical information regarding the input information. In the case of the extraction method being installed on the basis of the certain rule, there may be, for example, a method in which character strings described in the above dictionaries are searched for, and if two character strings the locations of which are near to each other are described among part names, failure expressions D1a, and action expressions D1b searched for in the above dictionaries, the two character strings are outputted as a pair.

The extraction results of the expression extraction unit 21 are temporarily stored in the temporary storage unit M. Contents stored in the temporary storage unit M as the results of the extraction output are illustrated in FIG. 8 as examples. Data contents stored in the temporary storage unit M shown in FIG. 8 is defined in M801 to M805. Source ID M801 is a column that houses source IDs, and these source IDs uniquely represent the numbers of documents in the maintenance execution log D1 that is brought in by the expression extraction unit 21. It will be assumed that one source ID is assigned to one maintenance/repair work. Data configuration shown in FIG. 8 shows that parts and descriptions (D1a and D1b) expressing failures and actions are described in the columns M803 to M805.

ID M802 is a column that houses extracted Ids, and these extracted IDs uniquely represent expressions extracted from the respective sources respectively. It is necessary that the extracted expression procedures are shown in Extracted ID. For example, EF_002_001 shows an expression with 01^{st} procedure among expressions extracted from a document with a source ID 002 and EF_002_02 shows an expression with 02^{nd} procedure, and it is necessary to make the order in which maintenance/repair works are executed understandable in such a way.

Part Name M803 is a column that houses extracted part names, Extracted Name M804 is a column that houses the expressions of extracted failures or the expressions of extracted actions, and Extraction Label M805 is a column that houses labels each of which shows whether the relevant expression in Part Name M803 is the expression of a failure or the expression of an action.

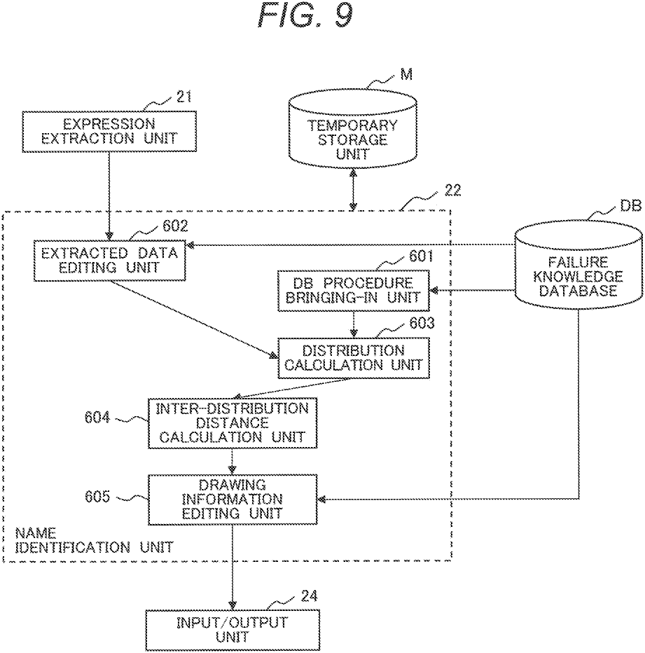

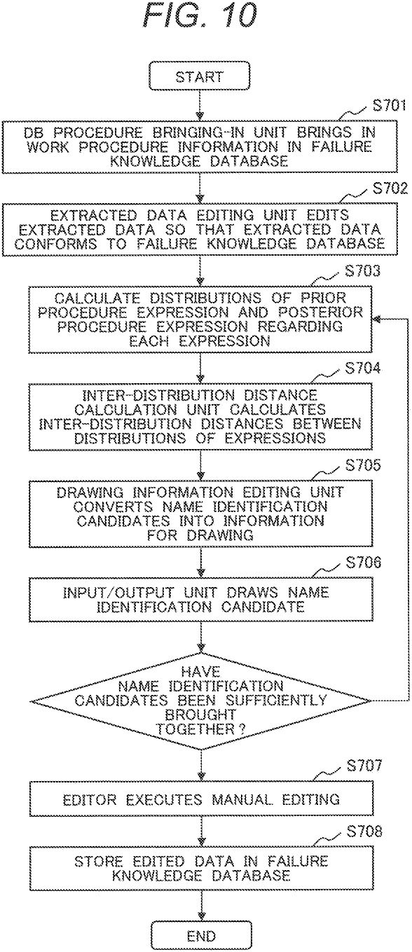

FIG. 9 is a diagram showing the processing contents of the name identification unit 22 in detail. In the name identification unit 22, name identification is executed on the failure expressions D1a and the action expressions D1b of the extraction results of the expression extraction unit 21 stored in the temporary storage unit M. The term name identification here is an act to judge whether there are similar expressions or not among the expressions included in the extraction results of the expression extraction unit 21 or among the expressions included in the extraction results and the expressions in the failure database DB from the viewpoint of maintenance.

The temporary storage unit M temporarily stores extraction result data and two prior/posterior procedure maps. The extraction result data shown in FIG. 8 is obtained as output results from the expression extraction unit 21, and the extraction result data is edited in the processing of the name identification unit 22. The pre/post-failure procedure map shown in FIG. 6 shows how many times failures, which are described as procedures occurring before or after a failure expression, occur when the failure expression is obtained, and similarly the pre/post-action procedure map shown in FIG. 6 shows how many times actions, which are described as procedures occurring before or after an action expression, occur when the action expression is obtained. The data of these prior/posterior procedure maps is obtained from the failure knowledge database DB, or are updated so as to include information newly obtained in the course of the extraction result data being processed and calculated in the name identification unit 22.

Name identification peripheral information, which is useful information for judging whether or not expression candidates obtained by name identification that are to be brought together and the name identification are correct, is passed to the input/output unit 24, and displayed outside to be provided to the database editor 19.; Furthermore, the database editor 19 enters editing operations into the failure knowledge database DB via the input/output unit 24.

The database editor 19 edits information to be stored in the failure knowledge database DB, and judges whether or not the name identification has been sufficiently executed by the name identification unit 22 in order to decide whether the name identification should be continued or not. Edited information operated in the input/output unit 24 is used for actual processing executed in the database editing unit 23.

Hereinafter, detailed processing contents executed in the name identification unit 22 will be explained. First, a DB procedure bringing-in unit 601 brings in information regarding the anteroposterior relationship of maintenance execution procedures necessary for the name identification processing (the prior/posterior procedure maps M901 and M902) from the failure knowledge database DB. The broughtin information is stored in the temporary storage unit M in the form of the prior/posterior procedure maps.

The extraction data editing unit 602 edits the extraction result data (FIG. 8) extracted by the expression extraction unit 21 so that the extraction result data coincides with information in the failure knowledge database DB.

A distribution calculation unit 603 calculates the distributions of prior/posterior procedures for each of the failure expressions and the action expressions by adding up the extraction result data edited by the extraction data editing unit 602 and prior/posterior procedure maps that are dealt with by the DB procedure bringing-in unit 601 and brought in from the failure knowledge database. In addition, after the name identification processing is executed once, if it is judged that the results of the name identification provided to the input/output unit 108 are insufficient, editing processing for editing the distributions on the basis of information brought together so far is executed.

An inter-distribution distance calculation unit 604 calculates distances between the distributions of all pairs of the failure expressions and distances between the distributions of all pairs of the action expressions on the basis of the distributions of the prior/posterior procedure of each of the failure expressions and the action expressions calculated by the distribution calculation unit 603. As the results of the calculation, if there is a distance smaller than a threshold, two failure expressions or two action expressions involved in the pair are set to be candidates to be brought together. The name-identified candidates as well as the name identification peripheral information, which is useful information for judging whether the name identification is correct or not, are drawn in the input/output unit 24.

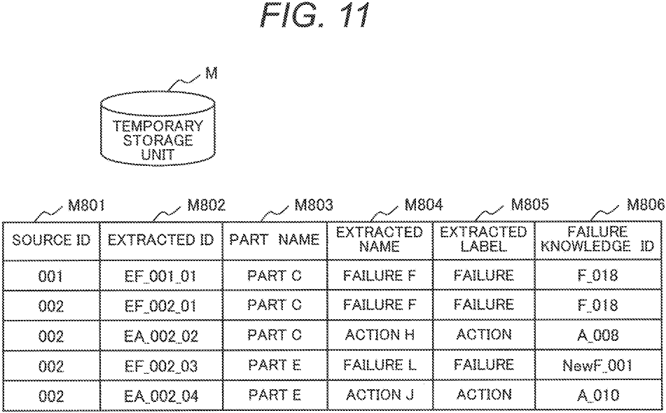

FIG. 10 is a flowchart showing the steps executed in the name identification unit 22, the input/output unit 24, and database editing. The flowchart starts at the time the processing at the expression extraction unit 21 is finished and ends at the time the database editor 19 completes its editing work and data is stored in the failure knowledge database DB.

At step S701 in FIG. 10, the DB procedure bringing-in unit 601 brings in information regarding maintenance execution procedures in the failure knowledge database DB. For example, with the use of data in Occurrence Frequency DN405 and Prior/Posterior Procedure Occurrence Frequency DN 406, which are properties in the failure node N108 shown in FIG. 4 as well as data in Occurrence Frequency DN505 and Prior/Posterior Procedure Occurrence Frequency DN 506, which are properties in the action node N107 shown in FIG. 5, the pre/post-failure procedure map M901 and the pre/post-action procedure map M902 shown in FIG. 6 are generated.

The pre/post-failure procedure map M901 shown in FIG. 6 is a table that shows the occurrence frequencies of one of the two failures and the three actions before and after the other failure occurs. And the pre/post-action procedure map M902 shown in FIG. 6 is a table that shows the occurrence frequencies of the two failures and two of the three actions before and after the other one action occurs. In the pre/post-failure procedure map M901 or the pre/post-action procedure map M902, there are descriptions regarding all the failure nodes (N106 and N108) and all the action nodes (N107, N109, and N110) stored in the failure knowledge database DB along the horizontal axis unlike the prior/posterior procedure occurrence frequency DN406 shown in FIG. 4 or the prior/posterior procedure occurrence frequency DN506 shown in FIG. 5. Furthermore, the occurrence frequency of each node of the failure nodes (N106 and N108) and the action nodes (N107, N109, and N110) regarding a certain node are divided into the occurrence frequency of each node occurring before the occurrence of the certain node and the occurrence frequency of each node occurring after the occurrence of the certain node, and these occurrence frequencies are described in the relevant cells respectively. If there is no occurrence frequency of a failure or an action to be described in the prior/posterior procedure occurrence frequency DN406 or DN506, 0 is entered in the relevant cell of the pre/post-failure procedure map M901 or the pre/post-action procedure map M902. The prior/posterior procedure occurrence frequencies of the failure nodes (N106 and N108) and action nodes (N107, N109, and N110) that are described in the failure knowledge database DB are described in the form of these frequencies being combined along the vertical axis. The pre/post-failure procedure map M901 and pre/post-action procedure map M902 that are generated in the above way are stored in the temporary storage unit M.

At step S702 shown in FIG. 10, in the extracted data editing unit 602, the extracted result data is edited so that the extracted result data conforms to the failure knowledge database DB. The extraction result data that is inputted at step S702 is data shown in FIG. 8, and it has already been stored in the temporary storage unit M.

The edited results are shown in FIG. 11. Data described in Part Name M803, data described in Extracted Name M804, and data described in Failure Knowledge ID (M806) are edited. Data described in Part Name M803 is replaced with data described in Part Name DN302 with reference to data described in Synonymous Expression DN304 described in FIG. 3 as a property of the part node N103 in the failure knowledge database DB.

As for Extracted Name M804, identical expressions are searched for from Synonymous Expression DN404 of the failure node N108 in FIG. 4 and Synonymous Expression DN504 of the action node N107, which are associated with Part Name M803, and if there is an identical expression, it is replaced with data in Failure Name DN402 or Action Name DN502.

As for Failure Knowledge ID (M806) in FIG. 11, the failure nodes (N106 and N108) and the action nodes (N106 and N108) are searched for whether there is a part node and an action node identical with data in Part Name DN803 and Extracted Name DN804 in FIG. 8, and if there is an identical node, Failure Knowledge ID (M806) stores data in Failure ID regarding the identical node in FIG. 4 or data in Action ID regarding the identical node in FIG. 5. If there is no identical node, an ID for an editing operation is provided independently so that a part name and an extracted name can be decided uniquely with reference to Failure Knowledge ID.

For example, “Part C′”, which is corresponding to “ERF_002_01” in Extracted ID (M802), in Part Name M803 in the 2^{nd} row in FIG. 8, is replaced with “Part C” and an identical failure ID “F_017” is stored in Failure ID (M806). In addition, since an extracted name in Extracted Name (M804) in the 1^{st} row does not exist in the failure knowledge database, a failure knowledge ID “NewF_001” is provided in Failure Knowledge ID M806 in FIG. 11.

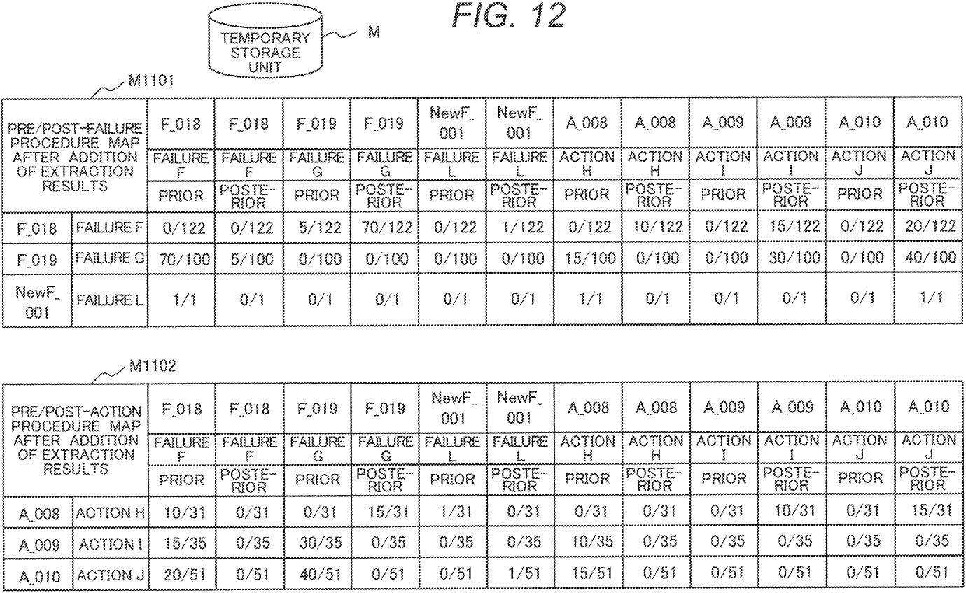

At step S703, the distributions of the respective expressions extracted from the maintenance execution log D1 and the expressions of pre/post-failure procedures and pre/post-action procedures extracted from the failure knowledge database DB are calculated by the distribution calculation unit 603. FIG. 12 shows the pre/post-failure procedure map M1101 after the addition of extraction results and the pre/post-action procedure map M1102 t after the addition of extraction results.

In this proceeding, first, the number of data pieces stored in Failure Knowledge ID (M806) that are identical with data pieces stored in the prior/posterior procedure maps in FIG. 6 is counted with reference to Failure Knowledge ID (M806) among the results that are obtained by editing the extraction results at step S702 and shown in FIG. 11, and the number is added to the denominator of the relevant row. For example, with reference to Failure Knowledge ID (M806) among the extraction results shown in FIG. 11, since the number of cells housing “F_018” regarding the failure F is 2, 2 is added to the original number of the denominator 120 in the 1st row, which describes “F_018”, in the pre/post-failure procedure map M1101 after the addition of extraction results so that the number of the denominator becomes 122.

Furthermore, with reference to Source ID (M801) and Extracted ID (M802) of the extraction results shown in FIG. 11, after checking failures and actions that occur before or after the relevant failure and action, the number of the failures and the number of the actions are added to the relevant numerators of the prior/posterior procedure maps respectively.

In addition, as for an item to which a new ID is given since the item does not exist in the failure knowledge database DB among data described in Failure Knowledge ID (M806) shown in FIG. 11, a row and a column corresponding to the item do not exist in any of the prior/posterior procedure maps, so that a new row and new columns are also added to the relevant map. For example, NewF_001 regarding a new failure L is added in each of the 3^{rd} row and two horizontal items of the pre/post-failure procedure map M1101 after the addition of extraction results. Furthermore, NewF_001 is added to two horizontal items of the pre/post-action procedure map M1102 after the addition of extraction results. Denominators and numerators are stored in cells designated by rows and columns that are added to prior/posterior procedure maps in accordance with the achievements of the extraction results. By executing the abovementioned operations, the distributions of the procedures occurring before and after the respective failure expressions and action expressions are calculated in the form of the prior/posterior procedure maps.

To put it briefly, this processing is processing in which, when an extraction result is newly generated, new empirical occurrence number is added to the relevant cells of the existing prior/posterior procedure maps, so that the empirical occurrence number of failures in parts and the empirical occurrence number of actions for the failures are accumulated. As a result, combinations of failures with high occurrence frequencies and actions with high occurrence frequencies, that is, the relationships of the occurrence orders of failures and actions can be more clarified.

At step S704, the inter-distribution distance calculation unit 604 calculates distances between the distributions of the failure expressions and distances between the distributions of the action expressions. In the pre/post-failure procedure map M1101 after the addition of extraction results and the pre/post-action procedure map M1102 after the addition of extraction results, distances between the distributions of all the combinations of the failure expressions and distances between the distributions of all the combinations of the action expressions described in each of the rows of the two maps are calculated. For example, distances between the distributions of all combinations of failure expressions described in the pre/post-failure procedure map M1101 after the addition of extraction results such as a distance between the distributions of F_018 and NewF_001 are calculated. A calculation method of distances may be any method that uses a Kullback-Leibler divergence, a Jensen-Shannon divergence, an L¹ norm, or an L² norm as long as the method can define distances in various distributions. After comparing the value of a distance with a value set as a threshold, if the value of the distance is smaller than the value of the threshold, the relevant pair of expressions is stored as candidates to be name-identified.

In the abovementioned processing, a pair of expressions means one of combinations of data D1c shown in FIG. 1, and it is a combination of a term expressing a failure and a term expressing an action, and a distance means the magnitude (number of times) of the term occurrence frequency information D1d. In addition, if there are two combinations of failure terms and action terms, and if these combinations have large empirical occurrence numbers respectively, it means that there is a possibility that these combinations are considered synonymous by executing name identification.

At step S705, in a drawing information editing unit 605, the name identification candidates obtained at step S704 are edited into information for drawing. Furthermore, in the drawing information editing unit 605, information regarding part structure expansion is obtained from the failure knowledge database DB. The failure expressions, the action expressions, and the pairs to be name-identified that are obtained at step S704 are brought together in units of associated parts. In addition, pieces of the name identification peripheral information, which is used when it is judged whether name identification is correct or not, are associated with the relevant failure expressions and action expressions. The name identification peripheral information includes information regarding procedures that frequently occur before or after failures or actions, the values of distances between other failure expressions and the values of distances between other action expressions, and the like.

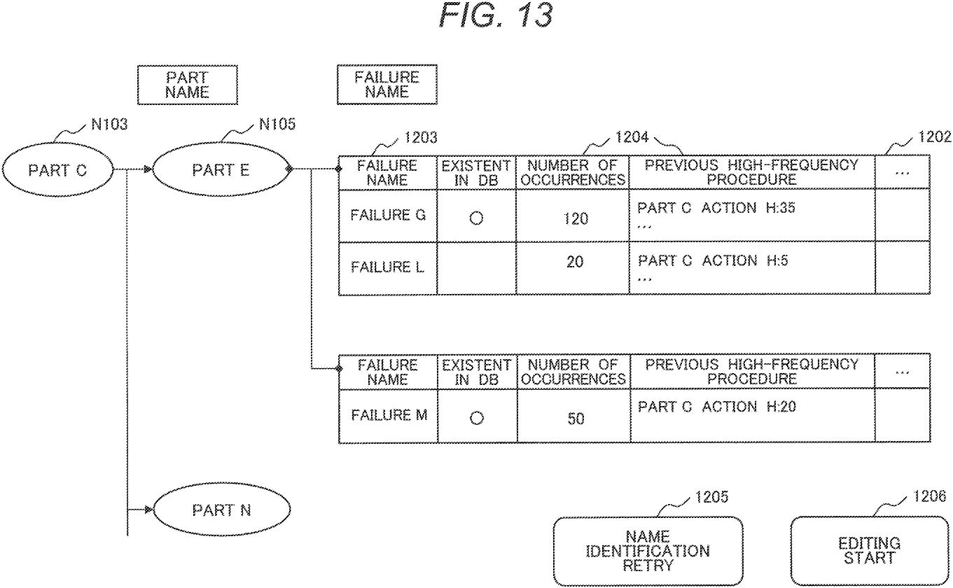

At step S706, the name identification candidates are drawn in the input/output unit 24. An example of a drawing regarding a failure expression is shown in FIG. 13. In FIG. 13, information of failure names is displayed in association with a part name. The part name is a part name associated with the failure expression, and information regarding the part structure expansion is drawn on the drawing screen of the input/output unit 24, so that a part can be selected from the part structure expansion. In an example shown in FIG. 13, a failure confirmation screen regarding the part E is drawn. Failure information associated with the part E is drawn in Failure Information 1202. Failure expression groups that are name identification candidates are listed in the same frame. In FIG. 13, “Failure G” and “Failure L” are drawn as name identification candidates, and “Failure M” is drawn as another failure expression group. Failure Information 1202 displays Name Identification Peripheral Information 1204 that is useful for manually judging whether name identification is appropriate or not as well as Failure Name 1203 of the failure expression. In FIG. 13, the list of the numbers of occurrences of failure expressions and the list of procedures that frequently occur before the failure expressions are shown as Name Identification Peripheral Information 1204. Even in the case of a drawing regarding an action expression, as is the case with FIG. 13, an action expression is drawn in association with a part, name identification candidates are drawn in the form of being brought together, and name identification peripheral information is also described.

The database editor 19 confirms the drawn name identification candidates and name identification peripheral information, and decides whether the name identification should be retried or manual editing should be started. If Name Identification Retry button 1205 is pushed, the name identification is retried. If Editing Start button 1206 is pushed, manual editing is started.

If the name identification is retried, the flow gets back to step S703. Data in the rows and columns of the name identification candidates of failure expressions and action expressions described in the rows and columns of the pre/post-failure procedure map M1101 after the addition of extraction results and the pre/post-action procedure map M1102 after the addition of extraction results are combined and the values of the relevant procedure occurrence frequencies are added up. After the above is executed, step S704 and the following steps are executed again.

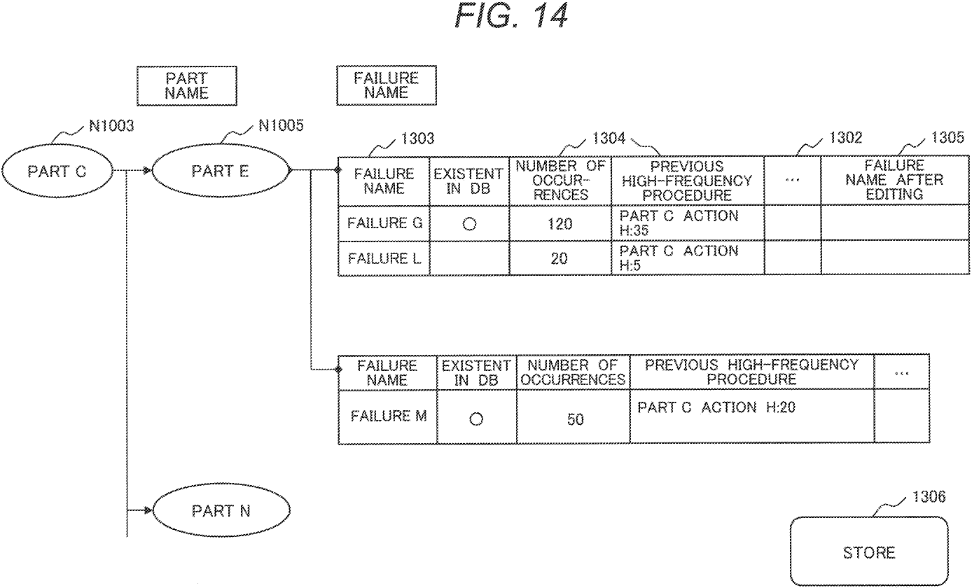

If Editing Start button 1206 is pushed, the flow proceeds to step S707. The database editor 19 manually edits name identification results. FIG. 14 shows an example of a manual editing screen of failure expressions. FIG. 14 shows a display with the same screen configuration as that shown in FIG. 13, and it is similar to FIG. 13 in that a part described in Part Name 1301 is selected from the part structure expansion, information described in Failure Information 1302 is drawn, and information described in Failure Name 1303 and Name Identification Peripheral Information 1304 are drawn. In FIG. 14, a column Failure Name After Editing 1305 is added after Failure Information 1302. Failure names are manually added in this column. If the name identification candidates are correct, the same failure name is described in each of the relevant rows. If the name identification is not correct, correct failure names are described in the relevant rows respectively. In the case of action expressions, as in the case with the failure expressions, editing is executed using a drawing similar to the drawing in FIG. 14. If editing is finished for all the expressions, Store button 1306 is pushed.

If Store button is pushed, the floe proceeds to step S708. At step S708, the database editing unit 23 reflects the edited results in the failure knowledge database DB. In the case of the failure expressions, a failure node is added to a newly added failure expression. Furthermore, even for existing failure expressions, values described in Occurrence Frequency DN405 and Prior/Posterior Procedure Occurrence Frequency DN406 regarding failures are updated, and at the same time, other expressions brought together in Synonymous Expression DN404 by name identification are added. Even in the case of the action expressions, an action node is added for a newly added action expression. Synonymous Expression DN504, Occurrence Frequency DN505, and the prior/posterior procedure occurrence frequency are updated for existing actions. With this, the flowchart regarding the name identification shown in FIG. 10 is ended. This is the end of the explanation of the second embodiment.

### Third Embodiment

In the second embodiment, although a name identification method used when information is extracted from the maintenance execution log D1 and the information is stored in the failure knowledge database DB, there are many cases where pieces of maintenance that have actually been executed are not described in the maintenance execution log D1.

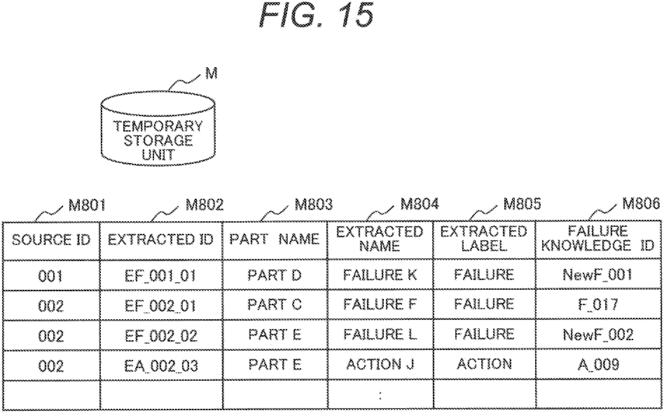

Data obtained by editing data, which is extracted by the expression extraction unit 21, in the extraction data editing unit 602 is illustrated in FIG. 15. Data corresponding to 002 in Source ID (M801) shows that, when the part C falls in the failure F, the action J is executed because it is estimated that the failure F of the part C is caused by the failure L of the part E. Since there is a description that, when the part C falls in the failure F, the action H should be executed on the part C as the following procedure in the failure knowledge database DB shown in FIG. 2, it is presumed that the above action H is not described in the maintenance execution log D1. In order to cope with such a situation, new pieces of processing are added to the processing of the name identification unit 22.

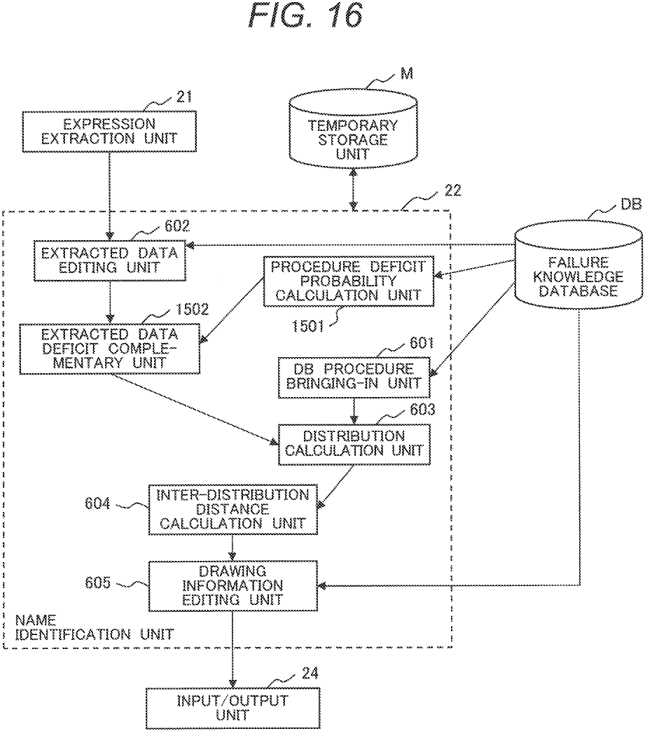

FIG. 16 shows the processing contents of a name identification unit 22 according to a third embodiment of the present invention in detail. The processing mechanism of the name identification unit 22 is shown. The configuration of the name identification unit 22 according to the third embodiment is equal to a configuration obtained by adding a procedure deficit probability calculation unit 1501 and an extracted data deficit complementary unit 1502 to the configuration of the name identification unit 22 of the second embodiment explained in FIG. 2.

The procedure deficit probability calculation unit 1501 calculates probabilities that what a type of content has a high possibility to fall in deficit when what a type of content is described on the basis of procedures regarding failures and actions described in the failure knowledge database DB. This result is stored in the temporary storage unit M and used by the extraction data deficit complementary unit 1502.

The extraction data deficit complementary unit 1502 complements procedures regarding the extracted data edited by the extraction data editing unit 602 on the basis of information of the procedure deficit probability calculation unit. Data obtained by this procedure complement is used by the distribution calculation unit 603.

The output of the procedure deficit probability calculation unit 1501 is shown in FIG. 17. The output shows a form like a procedure deficit probability table 1601. In the row and the column, information regarding failure nodes and action nodes are listed in the order of procedures described in the failure knowledge database DB. As for a value in a cell of the procedure deficit probability table 1601, if a failure or an action is described in the row corresponding to the cell, a probability that the action of the relevant column is not described in the failure knowledge database DB is described as a value in the cell. Although values in this procedure deficit table are calculated with reference to Prior/Posterior Procedure Occurrence Frequency DN406, Prior/Posterior Procedure Occurrence Frequency DN506, Occurrence Frequency DN405, and Occurrence Frequency DN505 in this embodiment, it is also conceivable that each failure node and each action node hold tables regarding their own deficit frequencies respectively as their properties, and these tables are used as needed. This procedure deficit table is calculated for every combination of procedures stored in the failure knowledge database DB.

The extraction data deficit complementary unit 1502 complements procedures on the basis of the procedure deficit probability table 1601 using extracted data described in FIG. 15 as input data. Processing executed by the extraction data deficit complementary unit 1502 will be explained using data described in rows including 002 in Source ID (M801) in FIG. 15 as examples. First, data that is included in the failure knowledge database DB is extracted from data stored in Failure Knowledge ID (M806) in the rows including 002 in Source ID (M801). In this example, F_017 and A_009 are selected. Next, a procedure deficit probability table 1601 including the largest number of extracted failure knowledges ID (M801) is selected from a procedure deficit probability table 1601 group.

In this case, it will be assumed that a table shown in FIG. 17 is selected. Next, it is judged whether or not a failure or an action that is not described in the extracted data should be complemented by calculating a complement-request point regarding the failure or the action. For example, when F_017 and A_009 are described in the extracted data, A_008 is not described with a probability 70/100 for F_017 and 40/50 for A_009 in the failure knowledge database DB, so that the complement-request point is 0.56 (=0.7×0.8). If the complement-request point is higher than a threshold preset in advance, complement is executed.

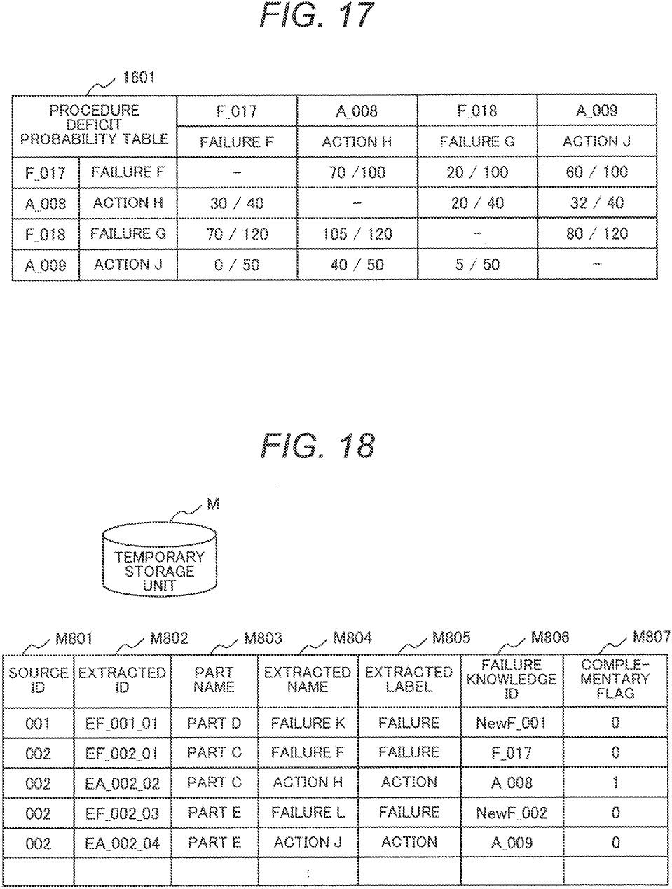

The output of the extraction data deficit complementary unit 1502 is shown in FIG. 18. A row having EA_002_02 in Extraction ID of rows including 002 in Source ID (M801) is newly added, where the row includes the part C and the action H in Part Name (M803) and Extraction Name (M804) respectively. FIG. 18 has a column Complementary Flag M807 in which a flag is described in order to trace which row has been complemented. The obtained data is transmitted to the distribution calculation unit 603, and name identification is executed by calculating distributions as is the case with the second embodiment. This is the end of the explanation of the third embodiment.

### REFERENCE SIGNS LIST

1: Failure Knowledge Structure System
19: Database Editor
21: Expression Extraction Unit
22: Name Identification Unit
24: Input/Output Unit DB: Failure Knowledge Database
M: Temporary Storage Unit
601: DB Procedure Bringing-In Unit
602: Extraction Data Editing Unit
603: Distribution Calculation Unit
604: Inter-Distribution Distance Calculation Unit
605: Drawing Information Editing Unit

What is claimed is:

1. A failure knowledge structure system comprising:
a failure knowledge database that accumulates and stores failures, execution procedures of actions and maintenance as maintenance information regarding a maintenance target instrument;
an expression extraction unit that extracts failure expressions and action expressions from a maintenance document that describes the maintenance information regarding the maintenance target instrument;
a name identification unit that calculates the occurrence frequencies of execution procedures of maintenance executed before the failure expressions and the action expressions and after the failure expressions and the action expressions on the basis of extraction results of the expression unit and information regarding the execution procedures of maintenance stored in the failure knowledge database, and that further calculates distances between distributions of the failure expressions and distances between distributions of the action expressions;
an input/output unit that draws processing results of the name identification unit as name identification candidates, and that makes it possible to execute manual editing operations; and
a database editing unit that edits information from the input/output unit and stores results in the failure knowledge database.

2. The failure knowledge structure system according to claim 1, wherein the results of the name identification processing are displayed in the input/output unit, one more instruction of name identification processing can be inputted into the input/output unit, and the processing of the name identification unit is executed again according to the one more instruction of name identification processing.

3. The failure knowledge structure system according to claim 1, wherein the input/output unit draws the name identification candidates and name identification peripheral information that is useful information for manual editing and used in the processing executed by the name identification unit.

4. The failure knowledge structure system according to claim 1, wherein failures and actions that cannot be extracted by the expression extraction unit are complemented from procedure information of the failure knowledge database in the name identification unit.

5. A failure knowledge structure method comprising the steps of:
extracting a plurality of failure expressions that describe failure contents of a maintenance target instrument and parts thereof and a plurality of action expressions that describe action contents executed against the failure contents from a maintenance document that describes maintenance information regarding the maintenance target instrument;
obtaining a combination of each of the plurality of failures and each of the plurality of actions, and executing name identification processing a certain number of times according to the number of descriptions of action expressions for a specific failure expression; and
reflecting information, in which a result of human judgment regarding the results of the name identification processing is reflected, in a failure knowledge database as failure knowledges.
